(19) United States
(12) Patent Application Publication
(10) Pub. No.: US 2020/0098045 A1
(43) Pub. Date: Mar. 26, 2020

(54) Virtual Currency Exchange Management

(71) Applicant: TILTING POINT MEDIA LLC, New York, NY (US)

(72) Inventors: J. Niklas Herriger, New York, NY (US); Andre Cohen, New York, NY (US)

(73) Assignee: TILTING POINT MEDIA LLC, New York, NY (US)

(21) Appl. No.: 16/698,540

(22) Filed: Nov. 27, 2019

Related U.S. Application Data
(63) Continuation of application No. 15/533,943, filed on Jun. 7, 2017, now abandoned.
(60) Provisional application No. 62/088,748, filed on Dec. 8, 2014.

(51) Int. Cl. G06Q 40/04; G06F 16/00; G07F 17/32; G06Q 20/06; G06Q 30/02; G06Q 30/06

(52) U.S. Cl. CPC G06Q 40/04; G06F 16/00; G07F 17/32; G06Q 30/00; G06Q 30/0207; G06Q 30/0601; G06Q 20/065

(57) ABSTRACT

According to an example for virtual currency exchange management, a list of virtual currencies that can be exchanged between a first application and a second application is determined, and a virtual currency exchange rate between a first virtual currency in the first application and a second virtual currency in the second application is calculated. The user is authenticated to the first and second application, and in the event that authentication is successful, the first virtual currency associated with the user is decremented based on the exchange rate and the second virtual currency associated with the user is incremented based on the exchange rate. In some examples, a redeemable asset, digital currency, cryptocurrency, or combinations thereof may be exchanged for a virtual currency based on a calculated exchange rate.

### CROSS-REFERENCE TO RELATED APPLICATIONS

This application is a continuation of application Ser. No. 15/533,943, which is a national stage application under 35 U.S.C. § 371 of International Application No. PCT/US2015/064253, filed Dec. 7, 2015, which claims the benefit of U.S. Provisional Application No. 62/088,748, filed Dec. 8, 2014, each of which is hereby incorporated herein by reference in its entirety.

### BACKGROUND

A significant share of computer software is now distributed through online application stores and available for download on a myriad of devices. Software applications may include features or components available for purchase within the application after an initial download, such as an “in-app” purchase. Software applications may also include or connect to a virtual economy, which may include virtual content and/or virtual goods. Different software applications and/or virtual economies may use different virtual currencies.

### BRIEF DESCRIPTION OF THE DRAWINGS

FIG. 1 illustrates a network-based system to manage virtual currency exchange between software applications, according to an example of the present disclosure;

FIG. 2 illustrates a flowchart of managing virtual currency exchange between software applications, according to an example of the present disclosure;

FIG. 3 illustrates a flowchart of calculating a virtual currency exchange rate based on at least one input; and

FIG. 4 illustrates a schematic representation of a computing device that may be used as a platform for exchanging virtual currencies, digital currencies, and/or redeemable assets, according to an example of the present disclosure.

### DETAILED DESCRIPTION

Examples of the present disclosure relate to the management of virtual currency exchange between virtual currencies in software applications, and/or between virtual currencies and real currencies, redeemable assets, digital currencies, cryptocurrencies, or other assets (“assets”) through a marketplace or other interchange, or as direct transactions between users. More specifically, the present disclosure relates to determining or calculating an exchange rate between virtual currencies and/or other assets based on at least one input such as user data (e.g., platform, device, game data, or progress data), location data (e.g., a current location or a local currency), contextual data (e.g., engagement, social media, or earn/buy/spend data), and/or balancing data (e.g., exchange rate agreements between applications or developers). The model for calculating an exchange rate may be trained on historical data that determines how each input or statistic independently and/or in assembly affects the exchange rate.

In general, the distribution of software has expanded from distribution on physical media to distribution over networks such as the internet, including through online application stores, app stores, or digital stores operated by various distributors. Electronic devices connected to the internet, or to other public or private networks, such as computers, servers, mobile phones, tablet computers, televisions, gaming consoles, home appliances, cars, any other device that is enabled for the internet, and other consumer electronics devices (hereinafter, simply “device” or “devices”) may connect to digital stores to download software. For example, a device may be shipped with an operating system and a base install of software applications (hereinafter an “application”, “app” or simply “game”) which may be, e.g., software for purchasing music, watching videos, monitoring stocks, or checking the weather. A user of the device (hereinafter “user”) may subsequently download additional apps from a digital store which may be, for example, apps for education, finance, gaming, social networking, sports, travel, or other interests.

In some examples, the digital store may be configured to sell or license applications, or provide software under any other commercial or non-commercial mechanism such as a trial period, freeware, freemium, shareware, or open source offering (hereinafter referred to interchangeably as a “purchase” or “download”). Apps may be pre-installed or downloaded either as a single component, or as modularized components. In either case, apps may allow for functionality or features to be selectively enabled or disabled based on certain criteria, e.g., a user purchase, an upgrade, an achievement, or other criteria based on the user or the app itself. Apps may include a virtual economy and/or virtual currencies, in-app purchase options with real or digital currencies, or both.

In an example of an app comprising or connected to a virtual economy, users may earn virtual currency or virtual money and exchange the virtual currency for virtual goods. Virtual currency may be an unregulated, digital currency issued and controlled by developers of an app or community, and used and accepted among the members of a specific virtual community. Examples of virtual currencies that are either unique to an app or shared between multiple apps may include coins, gems, diamonds, gold, silver, stars, virtual dollar notes, casino chips, tokens, ribbons, bullets, materials, crops, prestige levels, experience points, resources, energy, or hints. Note that the name or attributes of a virtual currency is not indicative of whether that currency is unique to one app or shared between multiple apps and that the latter is determined by the developer of each app or the respective communities. In some embodiments, for example in case of a subscription model, time may also be a virtual currency, broken down into units such as seconds, minutes, hours, days, weeks, months, or years.

Examples of virtual goods may include non-physical or intangible objects purchased or downloaded for use in games, apps, websites, marketplaces, online communities, and/or online games. Virtual goods may be non-consumable in that they are available to be used once, such as characters, avatars, vehicles, weapons, buildings, structures, tools, engines, and clothing. Virtual goods may also be consumable in that they may be stored in an account or storage to be used over time, such as ammunition, bullets, bombs, rockets, fuel, energy, time (e.g., minutes or hours), “retries” or “continues” (allowing the user to play another round).

Virtual goods may also be sold in subscription form, where the user's ability to use a good is based on a subscription model of a pre-set time, or virtual goods may be coupled with a rewards program. In an example, a rewards program may be a structured marketing effort that rewards, and therefore encourages, loyal buying behavior that is potentially beneficial to a company. Rewards programs may be referred to as loyalty programs, pay back programs, points programs, advantage programs, mileage programs, or club programs. Examples of rewards programs may include those offered by airlines, trains, cruise lines, hotels, gas stations, credit cards, brick and mortar stores, online stores, and/or restaurants.

As one example in the gaming context, a user may earn a virtual currency such as coins or gems during gameplay that can be exchanged in a virtual store for goods. A virtual economy may be critical for motivating a user to continue gameplay, and may be particularly important in games that use a “freemium” model (also known as “free-to-play” or F2P models) where basic features in an app are provided for free, with an upcharge for advanced features, functionality, or virtual goods.

In some examples, a developer may also allow a user to exchange real currency for virtual currency, such as the real currencies of the United States Dollar, the Euro, the British Pound, the Japanese Yen, or digital currencies or cryptocurrencies such as Bitcoin, or other mechanisms for conducting transactions or micro-transactions. In this example, in the gaming context, a user may pay a fee in real currency to unlock virtual currency that can then be used to buy virtual goods in a virtual economy or virtual store. In other words, a user may bypass the need to earn virtual currency by purchasing it with real currency.

Virtual economies and virtual currencies present possible revenue streams for application developers. As one example, app developers may generate revenue from purchases in real currency through the exchange of real currency for virtual currency. As another example, app developers may generate revenue from motivating the continued use of an application, e.g., through building user interest by way of virtual economies to increase user engagement and immersion, which in turn may drive more app downloads, app upgrades, virtual currency purchases with real currency, and in cases where apps are advertisement-supported, increased ad traffic and ad revenue.

In an effort to foster the engagement and immersion of users, app developers may seek to allow for the exchange of virtual currencies between apps, or between apps and redeemable assets such as physical gift cards, rewards cards, rewards programs, or mileage programs, or between apps and digital currencies such as Bitcoin, as examples. Allowing for the exchange of virtual currencies may maximize or minimize various factors for two apps or assets, including factors such as engagement, retention, churn, revenue, profit, player lifetime, life-time-value (LTV), win rate, loss rate, storyline, conversion from non-paying into paying user, in-app purchase (IAP) sales, cost-per-install (CPI), session length, number of sessions, number of sessions over time, unique levels played, number of virtual currency micro transactions between individual games, social media sharing, additional downloads, subscriptions, and/or renewals.

App developers presently lack systems and methods for determining which virtual currencies may be exchanged between apps or redeemable assets, and/or how to calculate an exchange rate between apps or redeemable assets or digital currencies, and/or what inputs or metrics can be used to accurately calculate an exchange rate. Such challenges may be amplified when an exchange is desired between apps or assets that are not controlled by a single party or single app developer, e.g., a cross-vendor arrangement. As one example in the gaming context, an app developer may seek to calculate how many virtual currency coins in a first app should be equivalent to 1,000 virtual currency coins in a second application, based on an exchange rate, or how many coins in a first application should be equivalent to a $100 value of a gift card or 1,000 airline miles, with the exchange rate influenced by various factors and subject to frequent change.

Similarly, users of apps lack systems and methods to exchange virtual currencies from one app or game to another, or between one app or game to a redeemable asset such as a gift card or hotel loyalty points or to other currencies. In some examples, a user may be motivated to exchange a virtual currency from one application, such as a game which is no longer interesting to the user, into a different virtual currency in another application, such as in a new game that is more appealing. In such examples, the virtual currency in the first game may be nearly worthless to the user.

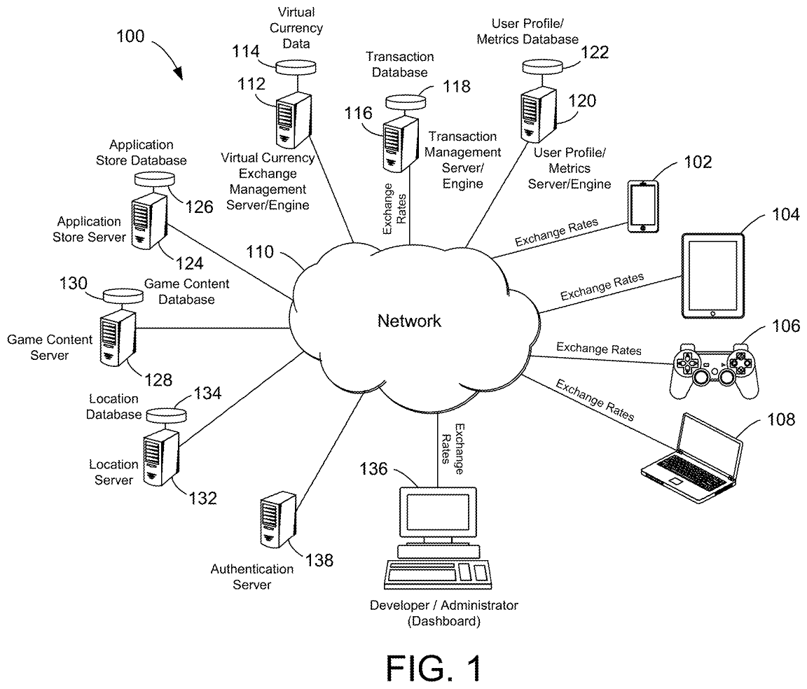

FIG. 1 illustrates a network-based system or “ecosystem” 100 to manage virtual currency exchange between software applications, according to an example of the present disclosure, or between virtual currencies and other assets. In an example, devices 102-108 represent user devices, such as smartphone 102, tablet 104, gaming console 106 (or other mobile or non-mobile gaming or computing platforms), and laptop (or desktop computer) 108. Devices 102-108 may include or execute at least one app downloaded from an app store, discussed in more detail below. In another example, apps may be streamed or otherwise transmitted via a network connection to a device or terminal, e.g., a web browser or thin client, where the software is not installed and/or locally stored. In another example, apps may be pre-installed on a device or terminal.

Apps installed on devices 102-108 may also include, embed, or access a software development kit (“SDK”) or portions of an SDK or code libraries (or an application programming interface, discussed below) enabled to provide functionalities related to the systems and methods described herein. The SDK or code libraries may be optimized to require a minimal amount of storage space to allow apps to remain small and downloadable over-the-air, e.g., without a WiFi connection and within the limits of a carrier cap for over-the-air downloads. Similarly, the SDK or code libraries may be optimized to be as computationally efficient as possible to not have app performance affected by the SDK functionalities, e.g., to not affect app loading, frame rates, etc.

In some examples, the SDK may make exchange rates accessible to an app or viewable in an app, notify the app of changes in exchange rates, and communicate exchange rate changes to the user via a user interface element such as pop-up alerts, message boxes, on-screen buttons, or push notifications. It will be appreciated that, in some examples, an application programming interface (“API”) may be used in place of, or in conjunction with, an SDK. For example, an app developer may program certain software calls to a server through an API using supplied URL specifications.

Ecosystem 100 may also include an application store server 124 and database 126, such as the app store discussed above for distributing software under any commercial or non-commercial mechanism. The application store server may allow users of devices 102-108 to browse available applications for download, and may also store information related to virtual currencies and/or virtual goods.

Ecosystem or “software environment” 100 may also include a game content server 128 and database 130, which may include data related to the actual content of a game or application, such as levels, items, characters, and other parameters affecting gameplay or application use.

Location server 132 and database 134 may receive or store information related to the geographical locations of users. For example, location database may store that a particular user is located in a particular country, in a particular state or province, at a particular latitude or longitude, or even at a particular neighborhood or street address. Location database 134 may also store information related to or derived from location data, such as a language that a particular user speaks or is likely to speak, or data related to user preferences in a particular location, such as a preferred application type, preferred in-app purchase, preferred virtual good, or combinations thereof, or preferred pricing levels or sensitivities.

Virtual currency exchange management server 112, which may comprise an engine, and database 114 may store and process data relating to virtual currencies or other assets for at least one app available on application store server 126. Server 112 may also be communicate with another server which may store data related to other assets, such as gift card balances or airline mile balances. The engine may collect various inputs and process the inputs into a model, as described below in more detail, to calculate an exchange rate between two or more virtual currencies or between a virtual currency and another asset. As discussed below in more detail, the various models may be trained based on data for a single user or a group of users, including historical data, current data, other inputs, or a combination thereof. In the event that more than one model is applied, the final output or outputs may be balanced by weights such that each model receives a specific amount of importance.

User profile/metrics server 120 and user profile/metrics database 122 may include general user profile information such as name, age, gender, app preferences, network carrier, and device type, as well as detailed behavioral data derived from application usage. In the example of a game, user profile/metrics server 120 may store game state and behavioral data such as player progress, levels, remaining lives, and other state and time data, as well as information for in-app purchases, virtual currencies, and virtual goods.

Data stored on user profile/metrics database 122 may be received from, e.g., devices 102-108. Data may be pulled or pushed from a device upon launching an app on a device, upon reaching a specific point in an app, e.g., a level, or at pre-set time intervals, etc. Alternatively, data may be pulled or pushed only when device resources are available, i.e., when the push or pull routine will not negatively affect app performance or gameplay. In some examples, data may also be pushed or pulled only when an internet or network connection is detected, or when a minimum bandwidth requirement is met. For some exchanges of virtual currency between apps (or to an asset), at least one app (or both of them) must be connected to the internet at the time of the exchange in order for the transaction to be executed. This may be set by the developer of the app, an agreement between multiple developers, and/or the operator of the exchange.

Transaction management server 116, which may comprise an engine, and database 118 may process transactions between apps and/or between apps and other assets. For example, transaction management server 116 may decrement a virtual currency from one app while incrementing a virtual currency in another app based on an exchange rate determined by, e.g., virtual currency exchange management server 112. Methods of storing transactions include, but are not limited to, single-entry bookkeeping, double-entry bookkeeping, and/or triple-entry bookkeeping.

Developer or administrator computer 136 may be a computer, such as a desktop computer, for displaying a dashboard or portal to report information related to virtual currencies, assets, and/or exchange rates. The dashboard may also report on other metrics useful to an application developer, such as organic virtual currency acquisition data, spending behavior, and player engagement, churn, or attrition.

The devices and servers of FIG. 1 may be coupled by network 110, which may be any public or private network such as the internet or an intranet. It will be appreciated that the servers of FIG. 1 may be the same server, may be co-located servers, or may be remotely-located servers. Similarly, the databases of FIG. 1 may comprise a single database with multiple related tables, or separate databases co-located, or located remotely of each other. Both server and database may either be operated by the exchange or a a third party.

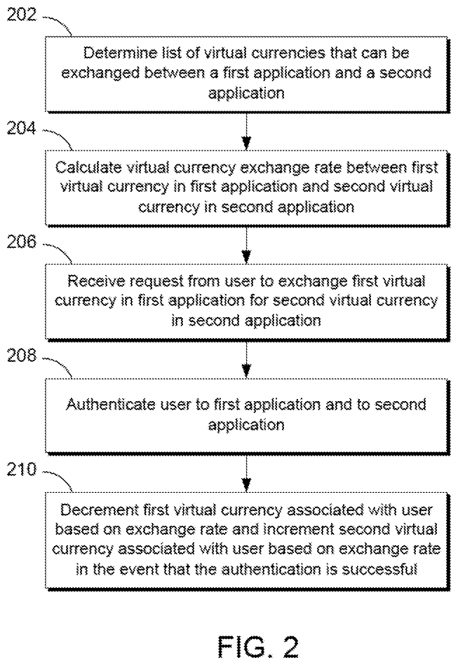

FIG. 2 illustrates a flowchart of managing virtual currency exchange between software applications, according to an example of the present disclosure.

In block 202, a list of virtual currencies that can be exchanged between a first app and a second app (or other asset) is determined. For example, a determination may be made that Game A and Game B may exchange virtual currencies, but Game A and Game C cannot. Similarly, a determination may be made that Game A may exchange virtual currencies with a gas rewards card, but not with an airline miles program. In some examples, the list may also be filtered based on users, such that exchange rates are different between particular users. The list may be displayed directly to a user through a user interface, e.g., on devices 102-108, or may be displayed on an exchange rate board or display, which may be sorted based on factors such as exchange rates or biggest percentage changes on, e.g., a daily or hourly basis. The following are examples of currency transactions that may be conducted.

In an example, virtual currency may be exchanged from Game A made by Game Developer A to Game B which is also made by Game Developer A. For example, 1,000 coins are deducted from Game A. Those 1,000 coins are then exchanged for 10 diamonds of the kind used in Game B, and those 10 diamonds are then added to the player's account in Game B.

In another example, virtual currency may be exchanged from Game A made by Game Developer A to Game B made by a different company, e.g., Game Developer B. For example, 50 emeralds from Game A may be exchanged for 1,000 wood in Game B.

In another example, one kind of virtual currency is transferred (not exchanged) from Game A made by Game Developer A to Game A, Part 2, which is also made by Game Developer A. For example, 500 coins from Game A are transferred to the sequel of Game A, called Game A, Part 2.

In another example, virtual currency from a game is exchanged for real currency. For example, 100,000 acorns are deducted from Game A, and $10 USD is added to the user's bank account B.

In another example, real currency is transferred to an app in order to buy virtual currency within that app. For example, EUR 5 are deducted from a credit card or a PayPal account in exchange for 50 love points in Dating App A or 100 diamonds in a Strategy Game B.

In another example, virtual currency from a game is exchanged for virtual currency in a rewards program. For example, 100,000 coins from Game A are exchanged for 100,000 miles in Airline Frequent Flyer Miles Program B.

In another example, virtual currency from a rewards program is exchanged for virtual currency in a game. For example, 5,000 rewards points from Credit Card A's loyalty program are exchanged for 500 stones in Game B.

In another example, virtual currency from a game is exchanged for multiple kinds of virtual currencies in another game. For example, 10,000 coins from Game A are exchanged for 500 poker chips and 100 slot machine tokens in Game B.

In another example, virtual currency from a game is exchanged for various kinds of virtual currencies in various other games. For example, 10,000 coins from Game A are exchanged for 1,000 diamonds in Game B and 300 emeralds in Game C.

In another example, multiple virtual currencies from multiple games are exchanged for virtual currency from a rewards program. For example, 500 wood from Game A and 500 coins from Game B are exchanged for 10,000 hotel points.

In another example, multiple virtual currencies from multiple games are exchanged for real currency. For example, 500 wood from Game A and 500 coins from Game B are exchanged for $10 USD.

In another example, virtual currency from a rewards program and a game are exchanged for virtual currency in another game, another rewards program, or real currency. For example, 100,000 Airline A Miles and 5,000 diamonds from Game B are exchanged for either 10,000 wood in Game C, 10,000 payback points from retailer D, or EUR 15.

In another example, real currency and virtual currency from a game are exchanged for virtual currency in a rewards program or game. For example, $500 USD and 3000 gold tokens from Game A are exchanged for 500,000 points from Rental Car Company B, or 1,000,000 fuel units in Game C.

In another example, virtual currency from one platform/ecosystem is exchanged for virtual currency on another platform/ecosystem. For example, 1,000 game dollars for the Sony Playstation 4 Game A are exchanged for 50,000 coins in the Apple iOS platform dating application App B or, in another example, 1,000 wood from Google Android platform Game C is exchanged for 50 gems in Facebook platform Game D.

In another example, virtual currency from one game is used to buy virtual goods in another game that uses a different virtual currency. For example, in order to buy a new car in Game B, 5,000 sapphires from Game A are transferred to Game B, which uses coins as its virtual currency. The user accesses the virtual store in Game B and pays directly with the virtual currency from Game A (5,000 sapphires) without having to first exchange the Game A virtual currency (sapphires) for the Game B virtual currency (coins).

In another example, virtual currency from a Game A is transferred to a rewards program that rewards customers for frequent purchases by providing gifts (e.g., free merchandise). For example, 200 poker chips from Game A are exchanged for rewards points in the “buy 9 coffees, get the 10th coffee for free” Coffee Rewards Points program from Food Retailer B. A customer that has already bought 7 coffees and thereby collected 7 Coffee Rewards Points could exchange the 200 poker chips from Game A for 2 additional Coffee Rewards Points in Food Retailer B's rewards program, thereby having a total of 9 Coffee Rewards Points and therefore being eligible for a gift (a free 10th coffee).

In another example, virtual currency from a Game A is exchanged for virtual currency from Game B, where Game A is an online game with a subscription-based access model that uses “time” as its virtual currency, and Game B is a mobile game that uses coins as its virtual currency. For example, 3 months of remaining subscription time in Game A's subscription are exchanged for 50,000 coins of Game B's virtual currency. Similarly, both Game A and Game B could be online games, both equipped with a subscription model, and the exchange would be exchanging a 5-day-subscription in Game A for a 5-day-subscription in Game B.

In another example, virtual currency from an online Marketplace M that requires a monthly subscription to gain access to the marketplace is exchanged for virtual currency for Game G that uses diamonds as a virtual currency. For example, a user that bought a monthly subscription for M and has 10 days remaining on that subscription could exchange those 10 days of “time” for 150 diamonds of game G's diamonds. The same would also apply for a situation where a user holds 1000 miles from Airline X's rewards program and 5000 wood from Game Y. The user may then seek to exchange both the miles and the wood for 2 weeks of “time” for a subscription in marketplace M's subscription.

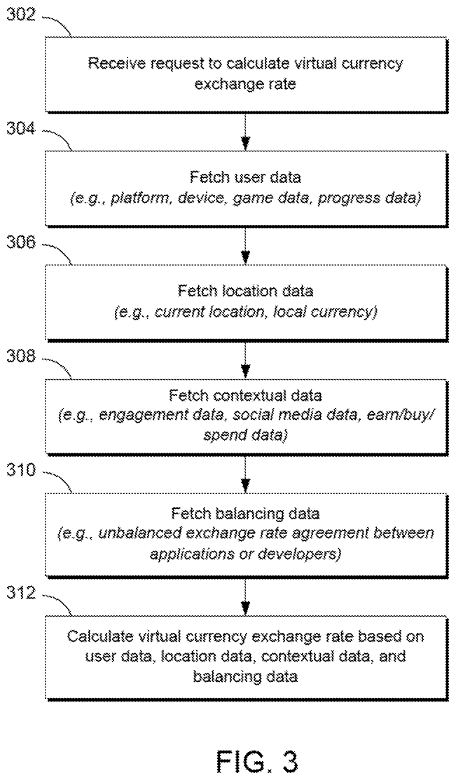

Following the step of block 202 for determining possible exchanges, in block 204, a virtual currency exchange rate between a first virtual currency in a first app and a second virtual currency in a second app (or another asset) is calculated. Calculating the virtual currency exchange rate is discussed below in more detail with respect to FIG. 3.

In block 206, a request is received from a user to exchange a first virtual currency in the first app for a second virtual currency in a second app. As discussed below, in some examples, the exchange may also be between a first app and a redeemable asset or a digital currency or other asset. In some examples, an exchange may be between multiple currencies or assets, such as between a first currency, a second currency, and a redeemable asset, or other combinations thereof. The user request may be received from a device, e.g., devices 102-108, via a user interface for conducting currency transactions. The user interface may also guide a user through the processes of conducting a currency transaction, confirming transactions, displaying past currency transactions, notifying the user of outstanding transactions that have occurred while an app was closed, and displaying the amount of currency the user has in every app the user has used.

In block 208, an authentication attempt is made to the first application and to the second application, or to an application storing or representing asset balances, such as gift card balances or airline mile balances. Authentication may comprise any suitable authentication process such as a username and password, biometric, OAuth, and/or two-factor authentication. Authentication may include techniques to provide protection from malicious attacks such as brute force password guessing. In some examples, unique tokens may be exchanged between an authentication server, user devices, or other components to enable authentication.

In block 210, in the event that the authentication is successful, the first virtual currency associated with the user is decremented based on the exchange rate and the second virtual currency (or asset balance) associated with the user is incremented based on exchange rate. For example, 1,000 coins in Game A may be exchanged for 2,000 gems in Game B, wherein the coin balance for the user in Game A may be decremented by 1,000 coins and the gem balance for the user in Game B may be incremented by 2,000 gems.

In some examples, the exchange of block 210 is handled by a virtual currency exchange management server or engine 112. The engine 112 may be responsible for, among other things, keeping track of currency exchanges that have been requested or executed, or are pending execution, notifying apps involved in the currency exchange that an exchange is taking place, and keeping track of user currency balances across all apps. Engine 112 may also be responsible for ensuring that transactions are not duplicated, and for rollback if necessary.

In some examples, if a user does not have an application open, e.g., on user device 102-108, the transaction may be placed into a queue until the application is re-opened, such that the application will immediately reflect a transaction and/or new balance when re-opened by the user. Such transactions may be transmitted individually or in batch.

FIG. 3 illustrates a flowchart of calculating a virtual currency exchange rate based on at least one input.

In block 302, a request is received to calculate a virtual currency exchange rate. The request may be received upon a user request to conduct an exchange (on-demand), or may be received or updated based on a periodic schedule, such as daily, hourly, or each minute, or may be received from an exchange rate board or display.

In block 304, in some examples, user data is fetched. The user data of block 304 may be an input to the model or algorithm of block 312, discussed below. In some examples, user data may comprise platform and/or device data. For example, user data may indicate whether the user is using iOS, Android, Windows, Facebook, Blackberry, Playstation, Linux, an embedded operating system, or another platform as an operating system, whether the device is a phone, tablet, laptop, game console, watch, headset or other wearable, or other device, and the brand, model, and/or generation of the device.

User data may also comprise current and/or historical user data for a single user or group of users. The data may include, in the example of a game, game state, game progress, levels played, rounds won, characters unlocked, highest level reached, most recent world unlocked, medals earned, achievements earned, missions completed, races won, puzzles solved, competitions participated in, a state or location in a decision tree, time, virtual good inventories, and/or virtual currency balances. Such information may be used to determine, for example, a virtual currency exchange rate, e.g., between different apps, currencies, assets, or users. The data may include, in the example of assets related to the user, user flight itineraries (e.g., preferred origin, preferred destination(s), preferred flight time, preferred airline, preferred seat class, preferred seat location, preferred payment method), user choice of coffee at local coffee shop (e.g., coffee type preference, coffee size preference, coffee preparation method preference, coffee additions preference, coffee origin preference, coffee flavor preference, milk preference, sweetener preference, payment method preference), user choice of sporting event tickets (e.g., sport preference, event type preference, venue preference, team preference, ticket type preference, such as single match, playoffs or season ticket, price tier preference, seat location preference, payment method preference), user preferences regarding music listening (e.g., artist preference, song preference, station preference, medium preference, streaming preference, playlist composition preference, music genre preference, audio quality preference, video quality preference, listening device preference, subscription type preference, payment method preference), user choice of on-demand transportation service (e.g., vehicle preference, travel time preference, vehicle size preference, route preference, additional vehicle feature preference, driver/pilot/operator preference, payment method preference), user choice of prepared food delivery (e.g., order location preference, restaurant preference, order time preference, cuisine preference, order volume preference, special demand preference, order item preference, tip preference, restaurant distance preference, restaurant rating preference, payment method preference), user choice of online retailer/e-commerce/marketplace (e.g., retailer preference, account type preference, merchandize class preference, item type preference, shipment type preference, quantity preference, discount preference, purchase time preference, delivery location preference, return policy preference, specific merchant preference, payment method preference).

Progress data may be represented by or measured by how a user progresses through an app, what kind of rank the user has reached in an app, what the user's average or highest score is, how many items the user owns, what the user's win-loss ratio is over a time period, etc.

In block 306, in some examples, location data is fetched which may include, e.g., a current location or a localization identifier for a user or device, and/or local currency data, either of which may be current and/or historical. The location data of block 306 may be an input to the model or algorithm of block 312, discussed below. For example, a user may be identified as being in the United States, while historical profile data may include data for users in the United States and other countries around the world. The data may also include information relating to weather, holidays, country spending habits, geographical trends, relative values of currencies to other currencies, a relative purchasing power indicator (e.g., Gross Domestic Product (GDP), Purchasing Power Parity (PPP), OECD Comparative Price Levels, Consumer Price Index (CPI), the “Big Mac Index”, the “iPad Index”, the Restaurant Index, etc.), and other metrics. Such information may be used to determine, for example, a virtual currency exchange rate, e.g., between different countries, different currencies, different economies, different locations, different marketplaces, different app stores, and/or different ecosystems.

In block 308, in some examples, contextual data is fetched. The contextual data of block 308 may be an input to the model or algorithm of block 312, discussed below. Contextual data may relate to time, engagement data, social media data, and/or earn, buy, or spend data of a user. For example, contextual data may be an engagement level based, e.g., on the frequency of actions of a user and/or the number of sessions during a day, while in another example, contextual data may be a percentage likelihood that a user is about to churn, e.g., leave an app and never return. Contextual data may be augmented with predictions or calculations of future actions, and/or other data related to market demands, competition, and geography, as examples.

More specifically, time data may be represented or measured by how frequently a user opens an app, the length of each of the user's sessions, the time of the day the user opens an app, the number of consecutive hours, days, weeks, or months the user opens the app, and other time-based metrics. Engagement data may be represented or measured by the number of interactions a user has with an app during a specified amount of time (hitting a trigger 5 times in 2 seconds, completing 10 puzzles in 1 hour, fighting 5 battles in 5 days, etc.). Social media data may be represented or measured by a number of Facebook friends a user has, the number of Twitter followers a user has, the number of Twitter accounts a user follows, how often a user tweets about a particular game, company and/or rewards program, how often a user posts a new score, accomplishment or any other news from an app to social media in a certain time span, how many friends the user has invited to an app, and/or whether the user was originally invited by another, pre-existing user.

Earn, buy, or spend data of a user may be represented or measured by how many different virtual currencies a user possesses, how much additional virtual currency the user organically earns by either actively playing a game or having an account with the game through the passage of time or receiving currency from a another player, how much virtual currency a user has of one virtual currency A compared to other virtual currencies B and C (all from the same game), how much virtual currency a user has spent, how many virtual goods a user has bought or received from other users, when a user bought the virtual goods or received them from other users, what kind of virtual goods a user bought or received them from other users, how many IAPB a user bought to gain more virtual currency as opposed organic acquisition, when a user bought IAPB, what the first virtual good purchased after an IAP purchase was, what IAP packages were bought by a user, whether the user is a repeat buyer, and whether the user is a receiver of virtual currency and/or virtual goods from other users.

In block 310, balancing data may be fetched. Balancing data may reflect various agreements between applications, developers, app stores, or even users; supply and demand data; or inflation or deflation data. For example, an agreement to “unbalance” an exchange rate may allow for a particular exchange rate to favor one virtual currency over another. There may be incentives for an app developer or an operator of a currency exchange to give an unfair advantage to Game A and/or B. This may include setting an unbalanced exchange rate so that more virtual currency is exchanged from Game A to Game B than from Game B to Game A. As illustrated in various examples below, there are various factors that can influence currency exchange rates.

In an example, virtual currency from one game may be more popular than virtual currency from another game. For example, Game A has 10,000,000 users, while Game B only has 50,000 users. Since Game A is much more popular than Game B, the virtual currency of Game A is valued higher than the virtual currency of Game B. Another example would be if Game A is ranked higher in an app store's “Free” or “Top Grossing” charts than Game B, the virtual currency of Game A is valued higher than the virtual currency of Game B. Another example would be if the users of Game A spend much more real currency on average in Game A than the amounts of real currency the users of Game B spend in Game B on average. Since the average per-user real currency spending in Game A is much higher than the average per-user real currency spending in Game B, the virtual currency of Game A is valued higher than the virtual currency of Game B.

The same concept of one virtual currency being more popular than another virtual currency may also apply to other scenarios, such as the exchange of virtual currency from Game Developer A's Game A to virtual currency of Retailer B's rewards program B; the exchange of Hotel C's virtual currency from rewards program C to virtual currency of Game Developer A's Game A; the exchange of Game A's time-based online-gaming subscription model A and Game B's time-based online-gaming subscription model B; the exchange of virtual currency from Newspaper A's time-based monthly subscription program to virtual currency from Newspaper B's time-based monthly subscription program, where newspaper A has a much larger readership than Newspaper B, and a 1-month subscription in Newspaper A is therefore exchanged for a 2-month subscription in Newspaper B.

In other examples, virtual currency may be very scarce in one game, but available in abundance in another game, such as where two games share the same currency. For example, in Game A, without buying additional currency for real currency through in-app purchases, the average user acquires 100 units of a resource (e.g. wood, iron) per hour by playing the game. To the contrary, in Game B, without buying additional currency for real currency through in-app purchases, the average user acquires 100,000 units of a similar resource (e.g. stone, oil) per hour by just playing the game. Because the virtual currency in Game A is very scarce compared to the virtual currency in Game B, the virtual currency of Game A is valued higher than the virtual currency of Game B.

The same concept of one virtual currency being very scarce while another virtual currency is available in abundance also applies to the exchange of virtual currency from Game Developer A's Game A to virtual currency of Retailer B's rewards program B; the exchange of Hotel C's virtual currency from rewards program C to virtual currency of Game Developer A's Game A; and the exchange of Poker Game P's virtual currency to the virtual currency of Roulette Game R. For example, customers of Hotel C earn 10 rewards program C reward tokens per night that they stay at Hotel C, while customers of Retailer B earn 10000 rewards program B points for every time they make a purchase in one of Retailer B's physical or online stores.

In another example, a game developer may have developed two games, Game A and Game B. Game A uses diamonds as a virtual currency, while Game B uses coins as a virtual currency. The developer has determined a specific exchange rate between the diamonds of Game A and the coins of Game B. For example, the game developer has determined that 1,000 coins from Game B equal 1 diamond from Game A. If a player of Game A would exchange 10 diamonds from Game A for virtual currency in Game B, he would receive 10,000 Game B coins in return.

The same concept of determining a specific exchange rate between two or more virtual currencies may also apply to instances where Game A is made by Game Developer A, and Game B is made by Game Developer B. Each game developer could specify an exchange rate for an exchange of the virtual currency in his game to the virtual currency in the other developer's game, and vice versa. The game developers could also collaborate and negotiate specific virtual currency exchange rates between their two games.

The same concept of determining a specific exchange rate between two or more virtual currencies also applies to the exchange of virtual currency from Game Developer A's Game A to virtual currency of Retailer B's rewards program B; the exchange of virtual currency from Game Developer A's Game A to real currency such as USD or EUR; the exchange of Hotel C's virtual currency from rewards program C to virtual currency of Game Developer A's Game A; the exchange of Game A's virtual currency from time-based (or time-remaining-based) subscription model A to another virtual currency or multiple virtual currencies, and vice versa; the exchange of Game A's virtual currency from time-based (or time-remaining-based) subscription model A to real currency, such as USD or EUR, and vice versa; and the exchange of railway corporation A's virtual currency from rewards program A to coffee shop C's “coffee stamps” rewards program and Newspaper N's monthly based subscription model N, and vice versa.

In addition to balancing data discussed above, currency exchange rates may also be determined based on supply and demand in the virtual currency exchange, similar to how currencies are traded on the foreign exchange market (also known are Forex, FX, or currency market). For example, if the supply of virtual currency for Game A is higher than the demand for virtual currency for Game A, the virtual currency of Game A will decrease in value compared to the virtual currencies for Game B, rewards points for Retailer C, and airline miles for Airline D that are available in less supply. As time passes, it will therefore take increasingly higher amounts of the virtual currency of Game A to for example buy a fixed amount of virtual currency for Game B. Another example would be if a lot of users try to exchange currencies from Game B, Retailer C, and Airline D for virtual currency in Game A, and the virtual currency of Game A is therefore in higher demand than the currencies from Game B, Retailer C, and Airline D. The virtual currency of Game A will increase in value compared to other currencies for Game B, Retailer C, and Airline D, meaning that it will take decreasing amounts of the virtual currency of Game A to for example buy a fixed amount of airline miles for Airline D.

In an example, virtual currency from one game may be subject to a higher “inflation” than virtual currency from another game. For example, Game A and Game B exchange virtual currencies. The developer of Game A implements changes into Game A that impact the amount of virtual currency that is available to the player, while the developer of Game B leaves Game B unchanged. For example, the developer of Game A may make Game A easier such that more virtual currency can be collected or earned in Game A, while the developer of Game B maintains a constant level of difficulty and therefore does not increase the level or speed at which virtual currency can be collected or earned by players in Game A.

Possible changes that could decrease the difficulty of Game A include, in one example, increasing the maximum amount of coins that the player can collect in Game A from 100,000 to 200,000 to increase the amount of coins that the average player collects. The amount of coins the player can collect in Game B remains unchanged.

In another example, the maximum amount of coins the player can collect in Game A could stay the same, but the player starts each round of the game with 5 lives instead of 3. This effectively increases the player's (average) lifetime, which in turn allows the player to collect more coins than before per round played in Game A. The amount of lives available per round to the player of Game B remains unchanged.

In another example, the game developer of Game A could decrease the level of difficulty of Game A. In a “jumping and running” game, controlling the character could be made easier. In a puzzle game, the speed of the game could be slowed down by 20%. In a shooting game, aiming for and hitting opposing players could be made easier. In a racing game, a visual guidance for the ideal line around a track, as well as acceleration and braking points, could be implemented. In a fighting game, the number of enemies and/or the strength of the enemies could be decreased. In a poker game, the odds of getting a pair of cards could be increased. In a roulette game, the odds of 0 or 00 coming up could be decreased. In a farming game, the chances of breeding a rare animal could be increased, and the chances of drought could be decreased. All these measures would lead to an overall easier game, thereby increasing the amount of virtual currency the player can collect while playing the game. Simultaneously, Game B remains unchanged.

In these examples, Game A may be changed in a way that effectively increases the amount of virtual currency that the average player collects over time, which leads to a devaluation of the virtual currency in Game A compared to the virtual currency in Game B, if Game B has remained unchanged.

In another example, the way assets are earmed could be modified. For example, earning Airline A's reward miles might become more difficult after Airline A decides to only provide rewards miles for business and first class tickets in the future. Similarly, pay back rewards points for Retailer R's rewards program might become more scarce when Retailer R decides to only reward purchases of full-price items. Similarly, earning Hotel H reward tokens might become less difficult if Hotel H increases the amount rewarded per night for rooms rented during weekends by 30%.

In another example, a Newspaper N may reward its subscribers with an additional free 3 days of subscription time for every quarter the subscribers continuously subscribes to N.

Unfair advantage/unfair exchange may also occur in order for the operator of an exchange to withdraw a specific amount of the currency being exchanged, for example from Game A in order to be used at a later time. A transaction fee or exchange fee charged by the operator of the exchange would be an example for the withdrawal of a specific amount of currency during a currency exchange. The currency withdrawn by the operator can be virtual currency, real currency, digital currency, or other assets. For example, the operator of the exchange may sell, on the exchange, currency and/or assets that the operator collected from transactions that took place on the exchange. In another example, the operator of the exchange may buy currency and/or assets on the exchange. In another example, the operator of the exchange may trade, on the exchange, currency and/or assets that the operator collected from transactions that took place on the exchange for other currency and/or assets that are traded on the exchange.

Incentives for an exchange to take place can also exist such as exchanging a single currency into multiple other currencies at the same time, or vice versa. For example, 1,000 coins from Game A could be exchanged for 20 wood and 40 oil from Game B; 5,000 gems from Game A could be exchanged for 100 nitros in Game B and 10 parachutes in Game C; 500 airline miles from Airline A could be exchanged for 30 payback points from retailer B and 5 diamonds from Game C; real currency (e.g., 10 EUR) could be exchanged for 5,000 coins in Game A, 5,000 diamonds in Game B, and 10,000 wood in Game C; 2,000 rental car rewards points from rental car company A and 200 sleep points from hotel chain B could be exchanged for 10,000 airline miles from airline C; 50 diamonds from Game A and 35,000 rewards points from credit card company B could be exchanged for $10 USD.

Additionally, the operator of the currency exchange may also develop one or more applications/games. Each of those applications/games may feature its own virtual currency (or set of virtual currencies). The applications/games developed by the operator of the currency exchange can then participate in all of the above currency trading/currency exchanging examples. Developing one or more applications/games that partake in the trading on the exchange may enable the operator of the exchange to create their own collection of virtual currencies that are traded on the exchange and that the operator issues and therefore fully controls. The operator of the currency exchange can then influence the exchange rates applied to the virtual currencies in its applications/games, for example by negotiating specific exchange rates with other game developers that have games that create virtual currencies that are traded on the currency exchange, or by inflating/deflating the value of the virtual currency in one of its games by making the game easier or more difficult. By fully controlling one or more currencies of the exchange, the operator of the exchange can also function as a “holder” of virtual currencies, similar to a bank holding real currencies.

In block 312, a virtual currency exchange rate is determined based on at least one of the factors fetched in blocks 304-310, e.g., user data, location data, contextual data, balancing data, or other factors. As discussed above, the model may be trained on any of the factors discussed herein, including historical data.

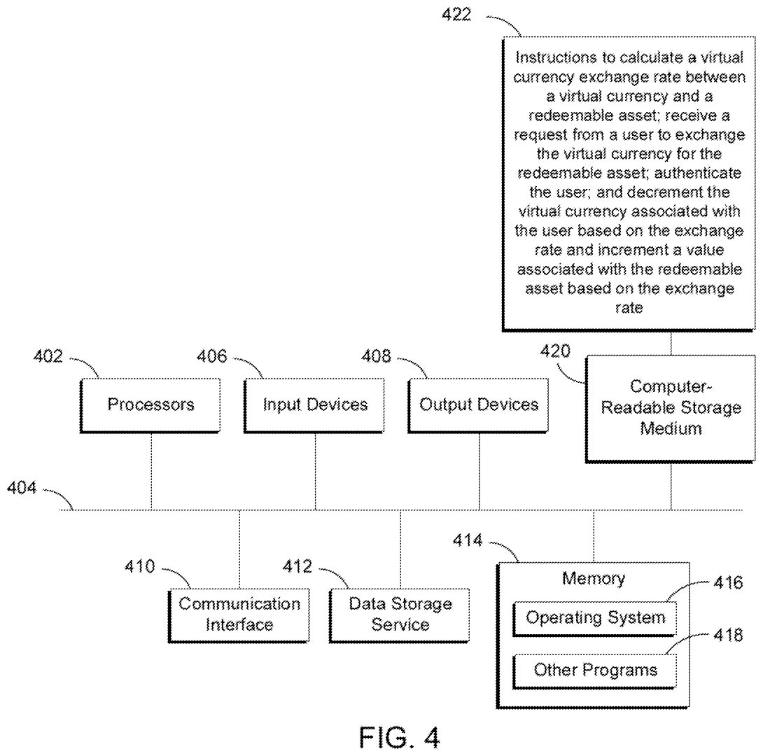

FIG. 4 illustrates a schematic representation of a computing device that may be used as a platform for exchanging virtual currencies, digital currencies, and/or redeemable assets, according to an example of the present disclosure.

In an example, device 400 comprises a processor or CPU 402, bus or other interconnect 404, input devices 406, output devices 408, communication interface 410, and data storage device 412. Device 400 may also include a memory 414, which may store an operating system 416 and other programs 418.

In some examples, device 400 may also comprise a non-transitory computer readable storage medium 420. More specifically, some or all of the operations set forth in the figures may be contained as a utility, program, or subprogram in any desired computer readable storage medium, distributed via remote computers or embedded on hardware. In addition, the operations may be embodied by machine-readable instructions. For example, they may exist as machine-readable instructions in source code, object code, executable code, or other formats. The computer readable storage medium may also store other machine-readable instructions, including instructions downloaded from a network or the internet. In an example, computer readable storage medium 420 may store instructions for carrying out the steps of FIGS. 2-3.

The computer readable storage medium may also store a firmware that may perform basic tasks such as recognizing input from input devices, such as a keyboard or a keypad; sending output to a display; keeping track of files and directories on a computer readable medium; and managing traffic on a bus. The network applications may include various components for establishing and maintaining network connections, such as machine readable instructions for implementing communication protocols including but not limited to TCP/IP, HTTP, HTTPS, Ethernet, USB, and FireWire.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A method of exchanging virtual currencies, comprising:
determining, on a processor, a list of virtual currencies that can be exchanged between a first application and a second application;
calculating, on the processor, a virtual currency exchange rate between a first virtual currency in the first application and a second virtual currency in the second application;
receiving, on the processor, a request from a user to exchange the first virtual currency in the first application for the second virtual currency in the second application;
authenticating, on the processor, the user to the first application and to the second application; and
decrementing, in a memory, the first virtual currency associated with the user based on the virtual currency exchange rate and incrementing the second virtual currency associated with the user based on the virtual currency exchange rate in the event that the authentication is successful.

2. The method of claim 1, wherein the virtual currency exchange rate is calculated based on historical application data.

3. The method of claim 1, wherein the virtual currency exchange rate is calculated based on user platform data and user device data.

4. The method of claim 1, wherein the virtual currency exchange rate is calculated based on a current location of a user, a local currency, and a relative purchasing power value.

5. The method of claim 1, wherein the virtual currency exchange rate is calculated based on user engagement data.

6. The method of claim 1, wherein the virtual currency exchange rate is calculated based on user progress data.

7. The method of claim 1, wherein the virtual currency exchange rate is calculated based on a social media value.

8. The method of claim 1, wherein the virtual currency exchange rate is calculated based on the value of virtual currency earned by a user.

9. The method of claim 1, wherein the virtual currency exchange rate is calculated based on the value of virtual goods purchased by a user.

10. A computing device comprising:
a processor;
a memory; and
a virtual currency exchange management engine to:
determine a list of virtual currencies that can be exchanged between a first application and a second application;
calculate a virtual currency exchange rate between a first virtual currency in the first application and a second virtual currency in the second application;
receive a request from a user to exchange the first virtual currency in the first application for the second virtual currency in the second application;
authenticate the user to the first application and to the second application; and
decrement the first virtual currency associated with the user based on the virtual currency exchange rate and increment the second virtual currency associated with the user based on the virtual currency exchange rate in the event that the authentication is successful.

11. The computing device of claim 10, wherein the virtual currency exchange management engine is to calculate the virtual currency exchange rate based on an unbalanced exchange rate agreement.

12. The computing device of claim 10, wherein the virtual currency exchange management engine is to calculate the virtual currency exchange rate based on device data of the user.

13. The computing device of claim 10, wherein the virtual currency exchange management engine is to calculate the virtual currency exchange rate based on location data of the user.

14. A non-transitory computer readable storage medium on which is embedded a computer program, said computer program to provide virtual currency exchange rate management, said computer program comprising a set of instructions executable by a processor to:
calculate a virtual currency exchange rate between a virtual currency in an application and a redeemable asset;
receive a request from a user to exchange the virtual currency in the application for the redeemable asset;
authenticate the user to the application and to an application associated with the redeemable asset; and
decrement the virtual currency associated with the user based on the exchange rate and increment a value associated with the redeemable asset in the event that the authentication is successful,
wherein the virtual currency exchange rate is calculated based on market data associated with the first application and the redeemable asset.

15. The non-transitory computer readable storage medium of claim 14, wherein the redeemable asset is a gift card.
